(19) United States
(12) Patent Application Publication
(10) Pub. No.: US 2012/0054604 A1
(43) Pub. Date: Mar. 1, 2012

(54) SYSTEM AND APPROACH FOR MACRO-ASSISTED DOCUMENT CODING

(76) Inventor: Hans J. Warncke-Wang, Golden Valley, MN (US)

(21) Appl. No.: 12/874,077

(22) Filed: Sep. 1, 2010

(51) Int. Cl. G06F 17/24; G06F 3/01

(52) U.S. Cl. 715/255; 715/704

(57) ABSTRACT

A system and approach for macro-assisted document coding (MADC). It may partially automate a document coding process by using a combination of hardware and software to increase document coding efficiency, speed and precision, with a use of macros. There may be viewer interface macros and coding interface macros. The viewer interface macros may incorporate page turning macros and single purpose macros such as, for example, document sizing or orientation for review. The coding interface macros may incorporate coding macros, recoding macros for coding that was correct but changed, and error correcting macros for coding that was incorrect. Keyboards with a few keys may be strategically located for fast coding, page turning, review, and accessing the next document for review and coding. Coding of a document may indicate its responsiveness, level of confidentiality and privilege. Coding may be used particularly for legal documents (MALDC), medical documents (MAMDC), and other kinds of documents.

### BACKGROUND

The present invention pertains to coding of documents, and particularly it pertains to computerized coding of legal, medical, and like kinds of documents.

### SUMMARY

The invention is a system and approach for macro-assisted document coding (MADC). It may partially automate a document coding process by using a combination of hardware and software to increase document coding efficiency, speed and precision, with a use of macros. There may be viewer interface macros and coding interface macros. The viewer interface macros may incorporate page turning macros and single purpose macros such as, for example, document sizing or orientation for review. The coding interface macros may incorporate coding macros, recoding macros for coding that was correct but changed, and error correcting macros for coding that was incorrect. Keyboards with a few keys may be strategically located for fast coding, page turning, review, and accessing the next document for review and coding. Coding of a document may indicate its responsiveness, level of confidentiality and privilege. Coding may be used particularly for legal documents (MALDC), medical documents (MAMDC), and other kinds of documents.

### BRIEF DESCRIPTION OF THE DRAWING

FIG. 1 is a diagram of an illustrative example of a legal document coding arrangement;

FIG. 2 is a diagram of the arrangement for macro assisted legal document coding;

FIG. 3 is a diagram showing a hierarchy of macros for document coding;

FIG. 4 is a flow diagram of paths for legal document coding selections;

FIGS. 5a and 5b are diagrams of an example screen where the coder may view a document being reviewed and make coding selections;

FIG. 6 is a diagram of a keyboard which may be used for macro-assisted coding of documents;

FIG. 7 is a diagram of a keyboard, having more keys than the one shown in FIG. 6, which may be used for macro-assisted coding of documents;

FIG. 8 is a diagram of various WASD finger positions on a keyboard which may be applicable in document coding;

FIGS. 9a, 9b, 9c, 9d and 9e are diagrams illustrating various macro types, hotkeys, voice commands, coding actions and the software packages which may used in a document review;

FIG. 10 is a diagram of an example of actions in a coding macro; and

FIGS. 11a, 11b, 11c, 11d, 11e and 11f are diagrams of various key layout patterns.

### DESCRIPTION

Electronic legal document coding consists of a database of documents and a coder, usually a licensed attorney or paralegal, examining the documents and then using a combination of computer mouse and keyboard inputs to enter coding for responsiveness, confidentiality and privilege into a legal document coding software package. The coder may also need to use mouse inputs to place checkmarks in displayed boxes in order to, for example, indicate a level of review and/or place a checkmark next to his or her initials as the person reviewing the document.

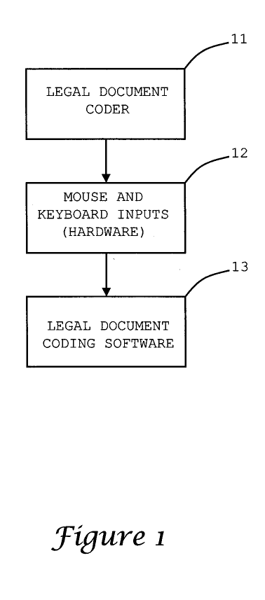

FIG. 1 is a diagram of an illustrative example of a legal document coding arrangement. The arrangement may have a legal document coder 11, mouse and keyboard inputs (hardware) 12 and legal document software 13, interconnected as necessary.

Coding is normally made by asking four questions about the contents of a document and making coding selections depending on the answer to those questions.

The present system and approach may improve the speed, precision and efficiency of legal document coding. Coding speed may be defined as the number of documents that a legal document coder can code in one hour of time. Coding precision may be defined as the percentage of documents which are completely and correctly coded, while coding efficiency may be defined as the number of completely and correctly coded documents per hour. One of the overall goals of any document coding project is to code all of the documents as efficiently as possible. In practice, coding speed and coding precision are inversely related. A legal document coder who moves too quickly from document to document will potentially miss important details necessary to correctly code a document or may fail to completely code the document, while a legal document coder who moves too slowly from document to document will increase the overall time for completion. Since attorneys or paralegals performing legal document coding are normally paid on an hourly basis, coding efficiency rather than coding speed or coding precision is the key measure in terms of overall cost.

Virtually all commercially available legal document coding software packages consist of two distinct components: (1) a viewer interface where the coder uses keyboard and/or mouse inputs to examine the document; and (2) a coding interface where the coder uses keyboard and/or mouse inputs to enter coding choices.

In some commercially available legal document coding software packages, the two components are clearly distinguished. Concordance™ (Concordance) by Lexis-Nexis™ (Lexis-Nexis) is an example of a commonly used software package with two separate components. The viewer interface (known as IPRO™ (IPRO) or Concordance Image™) may allow the coder to examine the document, while the coding interface (known as Concordance) may allow the coder to enter coding choices. In other software packages, for example Inview™ (Inview) by Kroll Ontrack or XLS Amicus™ (Amicus) by Xerox Corporation, the two components may have been merged into a single software package. For the purposes of this invention, it does not matter whether the two components of the legal document coding software package are separate or integrated.

In order to allow a coder to examine all of the pages of a multipage document, the viewer interface component of legal document coding software virtually always includes a way to turn the pages of the document being examined and a way make adjustments in terms of page size, zoom level and orientation. The number of separate mouse moves, mouse clicks and keyboard inputs necessary to code a single document can often run well into the double digits. Additionally, the documents are often coded in long blocks of homogeneous documents with similar page numbers and coding. This is particularly true when hard copy documents and/or documents scanned from existing physical documents, are being coded. Coding long blocks of homogenous documents may lead to the legal document coder needing to perform a substantial amount of repetitive coding actions which, over a period of time, have a tendency to cause repetitive strain injuries. A competent legal document coder is normally expected to be able to code between 400 and 600 documents during an 8 hour work period.

In order to reduce both the physical strain and the repetitive nature of the coding process, the present invention implements a system and approach that significantly reduces the number of inputs necessary to code a document. A version of the present system and approach that uses voice recognition hardware and software may allow the coder to code documents by voice input only, although this approach appears slightly slower than the approach which relies on physical coding inputs.

The present approach may work by inserting a layer consisting of hardware and software between the coder and the legal document coding software in order to at least partially automate the coding process. A first part of the layer may consist of a commercially available macro software package (for example Workspace Macro Pro™ (Workspace Macro Pro) which has been preconfigured to perform coding tasks by way of “macros” triggered with inputs of so-called “hot-keys.” A “macro” is a pre-recorded or pre-programmed pattern of mouse moves, mouse clicks and/or keyboard inputs which may be implemented with one keystroke. A “hot-key” may be a combination of keyboard inputs consisting of two or three keys pressed simultaneously, one of which is virtually always a function key, such as the shift, alt or control key, pressed in order to distinguish “hot-keys” from conventional keyboard inputs. To increase efficiency, pre-recorded macros are virtually always replayed at a higher rate of speed than the speed at which they were recorded.

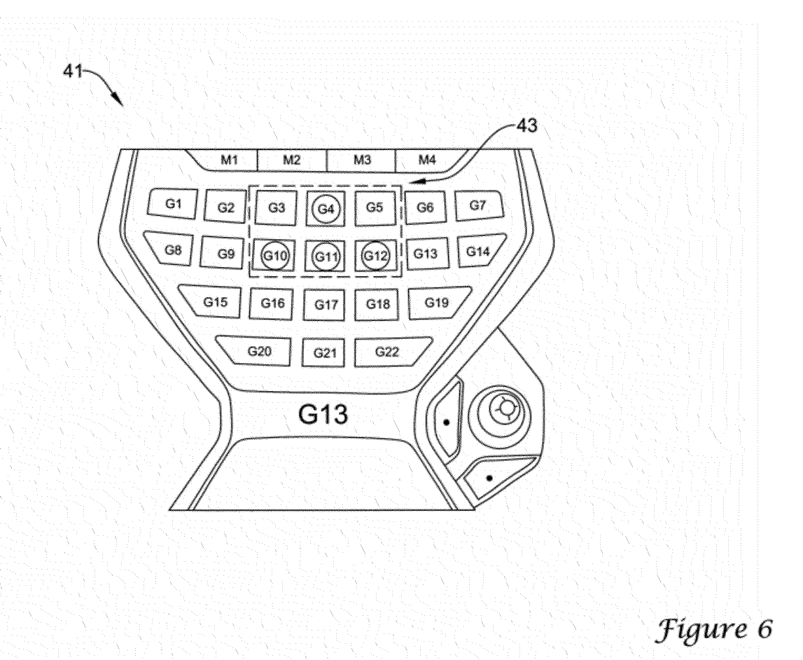

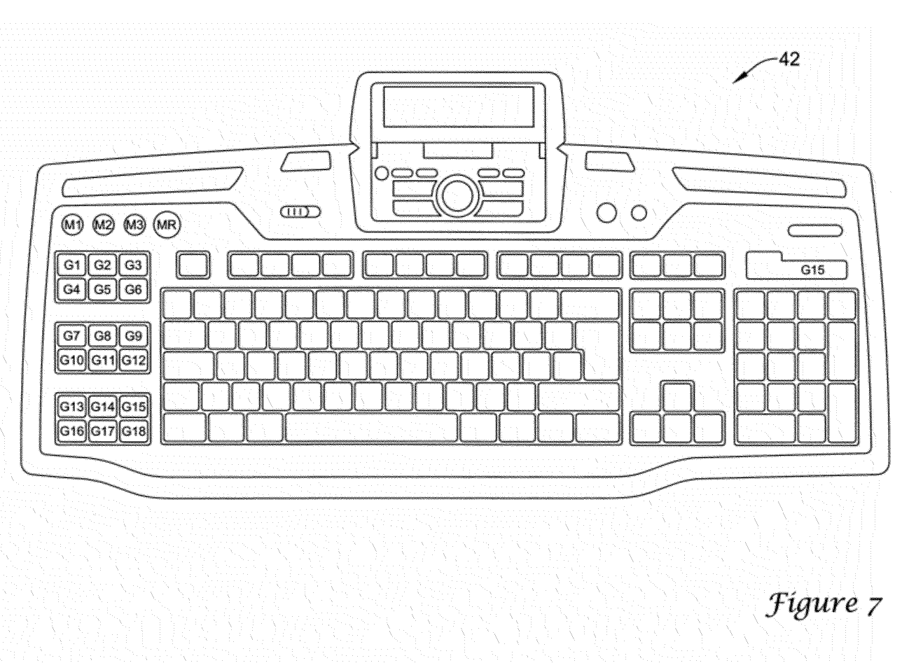

A second part of the layer consists of hardware, such as a specialized keyboard 41 with a selected group 43 of 6 keys and software (for example Logitech™ (Logitech) G13 (hardware), as shown in FIG. 6, and Logitech G-Series Key Profiler (software)), or a gaming headset (for example Logitech G330) and commercially available voice recognition software (for example VR Commander™ (VR Commander)) which have been pre-configured to output “hot-keys.” For more flexibility of a choice of keys for macros and the like, a larger deluxe keyboard 42 in FIG. 7, similar to some standard computer keyboards, may be used. Virtually any keys of keyboard 42 may be selected as a set to achieve macro-assisted viewing and coding of documents with the present approach.

The coder may enter his or her coding selections by speaking into the microphone part of the headset or entering inputs on a specialized keyboard such as keyboard 43. These inputs may cause the voice recognition software, or the software part of the specialized keyboard and software combination, to output “hot-keys” which, in turn, cause the pre-configured macro software package to replay the selected macro.

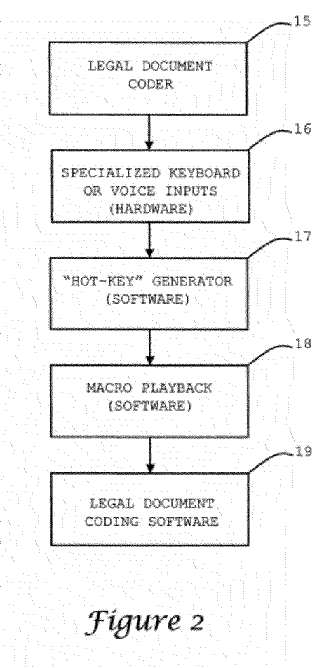

FIG. 2 is a diagram showing an arrangement for macro assisted legal document coding (MALDC). The arrangement may have a legal document coder 15, a specialized keyboard or voice input mechanism 16 (hardware), a “hot-key” generator 17 (software), a macro playback (software) 18, and legal document coding (software) 19, interconnected as necessary.

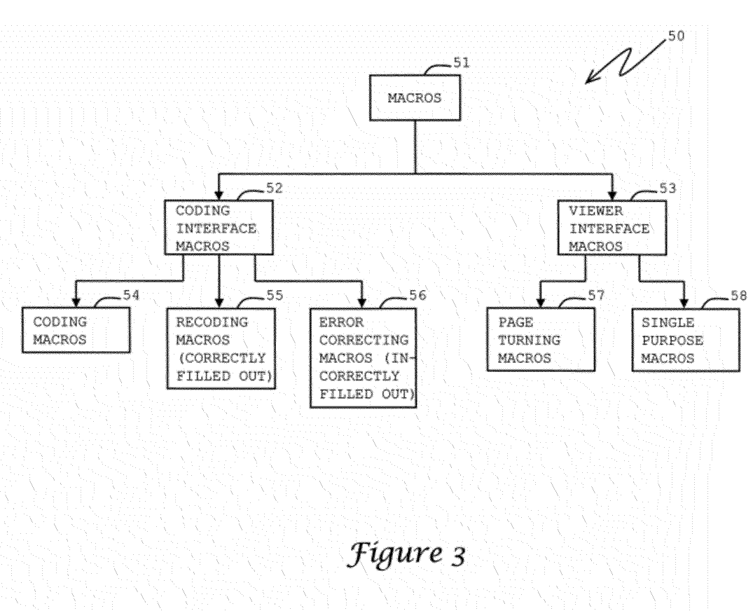

The present system may incorporate five particular types of macros. FIG. 3 is a diagram 50 showing a hierarchy of macros 51. There may be macros 51 for a coding interface 52 and viewer interface 53. Coding interface 52 may have coding macros 54, recoding macros 55 (for those correctly filled out), and error correcting macros 56 (for those incorrectly filled out). Viewer interface 53 may have page turning macros 57 and single purpose macros 58.

In order to allow the legal document coder to move from document to document in a seamless manner, macros virtually always begin and end with the mouse cursor at the same position on the screen of the viewer interface 53 or coding interface 52. This position may be either (1) a location in the viewer interface 53 of the legal document coding software where the pages are turned, or (2) a location in the coding interface 52 where an input to move to the next document is entered.

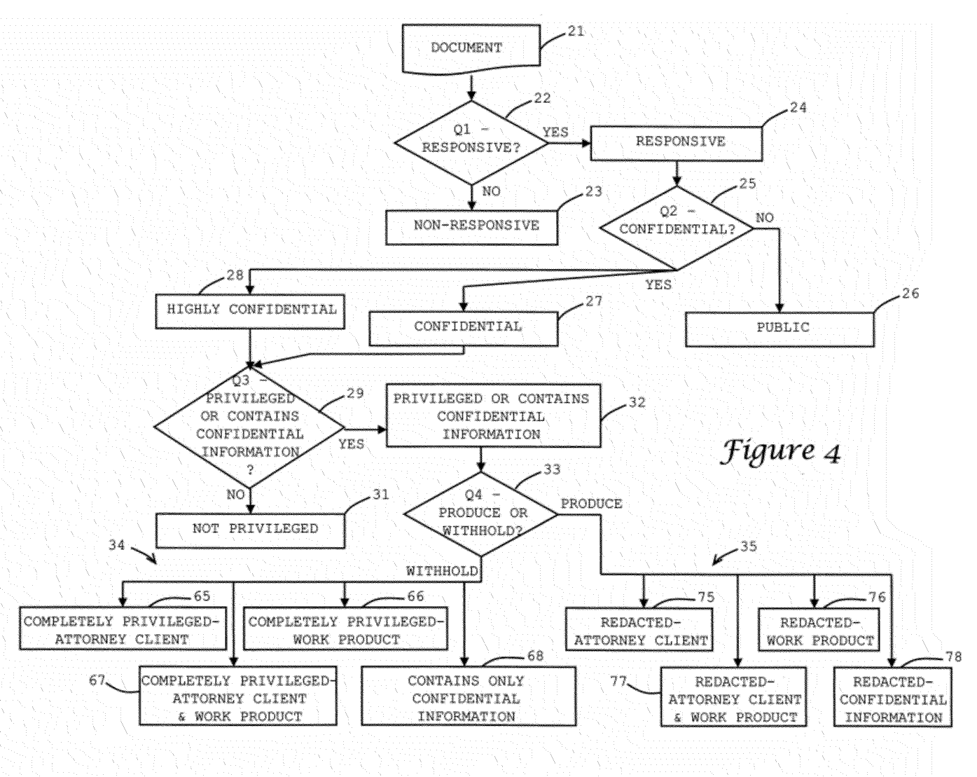

FIG. 4 is a flow diagram of an arrangement showing standard legal document coding selections. One may start with a document 21 to be coded. A first (1st) question at symbol 22 is whether the document is responsive. If not, then it may be considered as non-responsive at symbol 23 and that may be an end to consideration of such document. If yes, then the document may be considered responsive at symbol 24. A second (2nd) question at symbol 25 is whether the document is confidential. If not, then it may be regarded as public at symbol 26 and then the document need not be considered any further. If yes, then the document may be regarded as confidential at symbol 27 or highly confidential at symbol 28. If the document is regarded as confidential or highly confidential at symbols 27 and 28, respectively, then a third (3rd) question as to whether the document is to be regarded as privileged or as containing confidential information in need of redaction may be asked at symbol 29. If the answer is no to both questions, then the document is to be regarded as not privileged as indicated at symbol 31, and the document need not be considered any further. If the answer is yes, then the document is to be regarded as privileged or as containing confidential information at symbol 32. If the document is regarded as privileged or as containing confidential information, then a fourth (4th) question of whether the document is to be produced or withheld may be asked at symbol 33.

If the document is deemed to be withheld at line 34, then the document may be regarded as either “completely privileged—attorney client” at symbol 65, “completely privileged—work product” at symbol 66, “completely privileged—attorney client & work product” at symbol 67, or “contains only confidential information” at symbol 68, and then the document need not be considered any further. If the document is deemed to be produced at line 35, then the document may be regarded as either “redacted—attorney client” at symbol 75, “redacted—work product” at symbol 76, “redacted—attorney client & work product” at symbol 77, or “redacted—confidential information” at symbol 78, and then the document need not be considered any further.

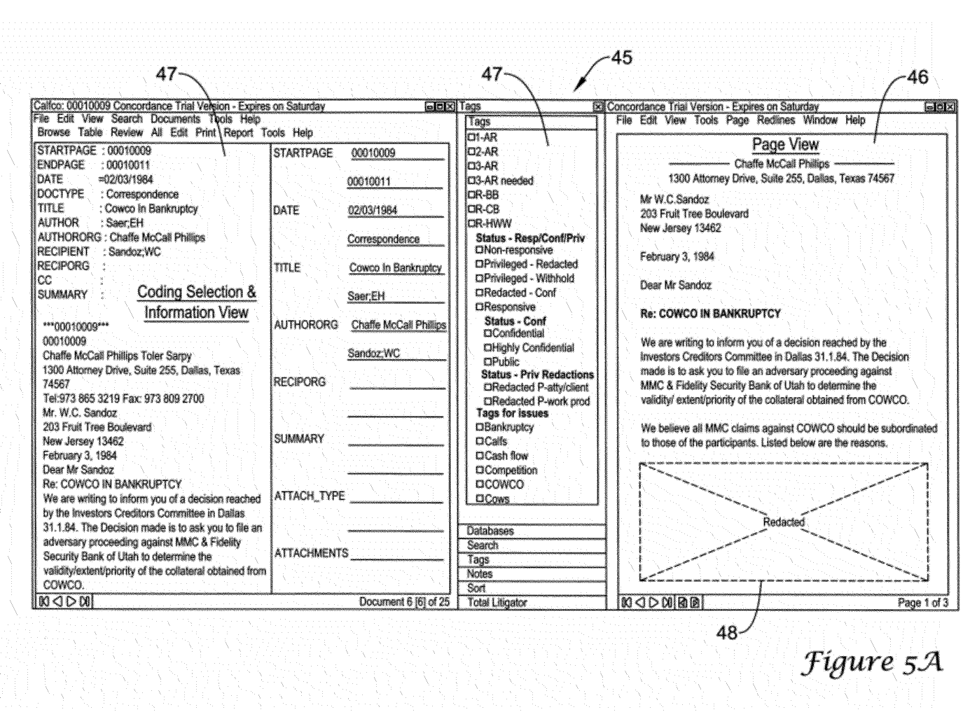

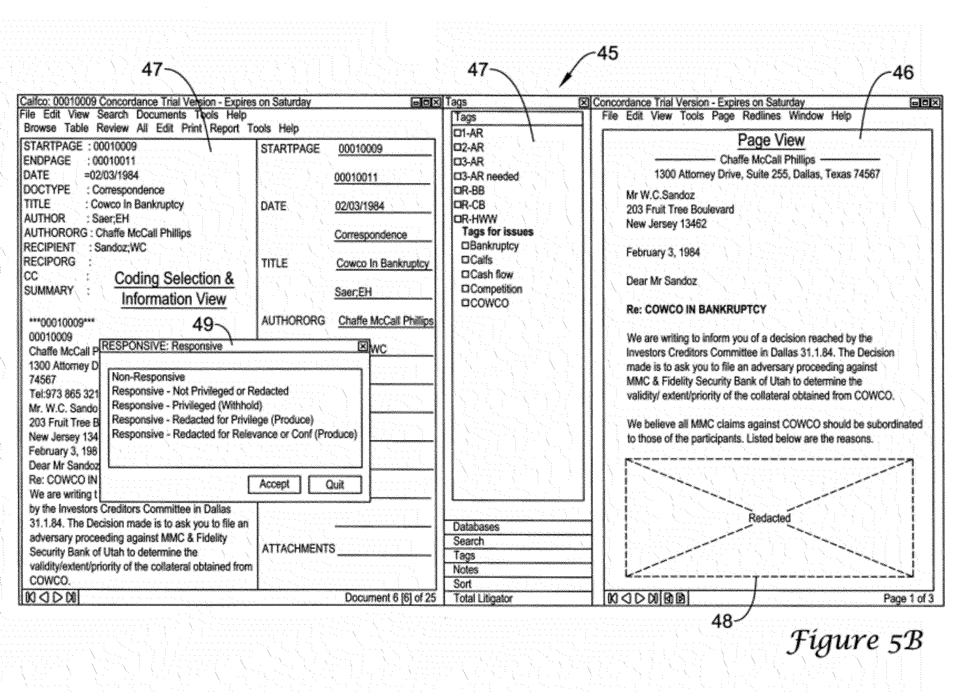

FIG. 5a is a diagram of an example screen 45 where the coder may view a document being reviewed and make the appropriate coding selections for that document using checkmarks. In this example, a page view 46 of the viewer interface 53 may be shown on the right side of screen 45, and the coding selection and information view 47 of the coding interface 52 may be shown on the left side of the screen. The positions of these views 46 and 47 may be arranged differently than as shown.

Material in the document shown by page view 46 may be redacted as indicated by an example box 48. The redaction may be decided and effected as necessary by the coder. FIG. 5b has a similar screen as that of FIG. 5a, except that FIG. 5b shows a drop down box 49 which appears on screen 45 in view 47 and indicates a coder's decision. A key difference between FIG. 5a and FIG. 5b is that the checkmarks that were used to enter coding choices in FIG. 5a have been replaced with drop down boxes in FIG. 5b. This can most easily be seen by observing the significantly shorter list of “Tags” in FIG. 5b. The coder's decision in FIG. 5b may be “Non-Responsive”. Box 49 may have two buttons, “Accept” and “Quit”. The coder may click on one of the buttons to proceed.

Coding macros may enter the legal document coder's selections as to responsiveness, confidentiality and privilege. In most commercially available legal document coding software packages, the coder's decisions may be selected either by use of drop down boxes or by entering check marks. It may also be possible to enter a coding choice by having a macro enter text in a field within the legal document coding software. The macro may move the mouse cursor to each drop down box, or check box, and click in order to select the appropriate choice. In instances where it is necessary to place additional check marks in check boxes, for example indicating the level of coding or the coder's initials, the macro may move the cursor to the check boxes and click to enter the appropriate choices. The standard legal document coding selections are shown in FIG. 4. There may be a total of 18 or so possible coding macros for legal document coding as indicated in the following.

### a) Non-responsive;

### b) Responsive, Highly Confidential;

### c) Responsive, Confidential;

### d) Responsive, Public;

### e) Responsive, Highly Confidential, Completely Privileged, Attorney Client;

### f) Responsive, Highly Confidential, Completely Privileged, Work Product;

### g) Responsive, Highly Confidential, Completely Privileged, Attorney Client and Work Product;

### h) Responsive, Confidential, Completely Privileged, Attorney Client;

### i) Responsive, Confidential, Completely Privileged, Work Product;

### j) Responsive, Confidential, Completely Privileged, Attorney Client and Work Product;

### k) Responsive, Highly Confidential, Redacted for Confidentiality;

### l) Responsive, Confidential, Redacted for Confidentiality;

### m) Responsive, Highly Confidential, Redacted for Privilege, Attorney Client;

### n) Responsive, Highly Confidential, Redacted for Privilege, Work Product;

### o) Responsive, Highly Confidential, Redacted for Privilege, Attorney Client & Work Product;

### p) Responsive, Confidential, Redacted for Privilege, Attorney Client;

### q) Responsive, Confidential, Redacted for Privilege, Work Product;

### r) Responsive, Confidential, Redacted for Privilege, Attorney Client and Work Product.

There may be two different types of confidentiality encountered when coding documents using legal document coding software. A first type of confidentiality may relate to the overall confidentiality level of the document being coded, i.e., highly confidential or confidential. The second type of confidentiality may relate to whether a document contains confidential information that needs to be redacted, for example, social security numbers, credit card numbers, or birthdates. Public documents are not redacted. Coding choices that involve redactions therefore only involve either confidential or highly confidential documents. A coding choice to code a document as completely confidential because it only contains confidential information is not necessarily used in practice because such a document will virtually always be non-responsive.

In practice, many databases subject to legal document coding may contain a high number of documents which are (a) Non-Responsive, (b) documents which are Responsive/Highly Confidential, or (c) documents which are Responsive/Confidential, and a relatively low number of (e-j and m-r) documents which are Privileged, or (k-l) documents which are redacted for Confidentiality. Creating coding macros to allow the coder to make all 18 of the coding selections set forth above is possible, but not necessarily practical, and there may often be a point somewhere in between the most used and the least used coding selections where the coder will begin coding by hand rather than with the assistance of macros.

A recoding macro is a macro that changes the coding choices entered by a coding macro. How a recoding macro works may depend on the coding software package used, and can include selecting from drop down boxes, deleting or moving check marks or erasing previously entered text. A recoding macro may be used in one of two circumstances: (1) when the legal document coder changes his or her mind as to the coding selection during the coding process, or (2) when the legal document coder subsequently receives instructions to change the coding selection.

A page turning macro is a macro that may enter a number of mouse clicks with a preset delay between each mouse click for turning a page, usually ranging from 700 to 2000 milliseconds. When a specialized keyboard is used, there may normally be macros that enter 1, 3, 5, 7 and 10 mouse clicks with a preset delay between each mouse click. For coding larger documents, a separate macro may be used that continuously pages forward or backward through the document until it is stopped. When voice recognition software is used, there may normally be macros for each number of pages between 2 and 10 allowing the legal document coder to speak the number of pages in order to have the software trigger the macro corresponding to that particular number of pages. For coding documents more than 10 pages in length using voice recognition, the same type of macros used to code larger documents with a specialized keyboard may be configured to be triggered by voice commands such as “forward,” “backward” and “stop.”

A single purpose macro is a macro that completes a single task, such as changing the page size or zoom level of the document the coder is examining. Legal documents may often be scanned in a number of different resolutions and it is sometimes necessary to click a “resize” button in order to make the coding software display the entire page. A macro assigned to this task will move the mouse cursor from the point of origin to the “resize” button and enter a mouse click at that location before moving back to the point of origin. A task may be effectively zooming in at a particular area of a page being reviewed. Macros that enter a single keyboard input, such as the “Esc” key, may also be single purpose macros.

An error correcting macro is a macro that corrects errors done by a coding macro or a recoding macro. Delays in the updating of the legal document coding software, or connection delays when the coder is working remotely, can sometimes lead to documents being coded incorrectly. Because of these errors, it is necessary to provide the coder with the option of using error correcting macros. Error correcting macros may be single purpose macros or multiple purpose macros depending on the type of error being corrected. Virtually any error correcting macro moves from the point of origin to the location where the error occurred, makes the necessary corrections and then returns to the point of origin. Because of the speed with which a macro moves, it is possible to run both a coding macro and an error correcting macro in less time than it would take a document coder using manual inputs to code the document.

In order to increase coding efficiency further, the five mentioned macro types may be configured to work in three different ways: (a) non-anticipatory macro assisted coding, (b) non-anticipatory macro assisted coding with look-ahead, or (c) anticipatory macro assisted coding.

Non-anticipatory macro assisted coding without look-ahead indicates that the coder examines the document by examining each page of the document with the assistance of page turning macros before triggering the coding macro necessary to code the document by keyboard input or voice command. Once the coding macro has completed its coding, the coder verifies that the coding macro has entered the proper selections and checked boxes before triggering a single purpose macro that moves both the coding and viewer interfaces of the legal document coding software to the next document. This approach most closely resembles the traditional approach of coding legal documents. This approach adds to the speed and efficiency of macros, but is slower than non-anticipatory coding with look-ahead or anticipatory coding. By using this approach, a competent legal document coder may code between 100 and 150 documents an hour, or between 800 and 1200 documents in an 8 hour period.

Non-anticipatory macro assisted coding with look-ahead is a hybrid approach and works on legal document software coding packages that include the ability to look at the next document in the viewer interface before the coding interface is moved to the next document. Concordance by Lexis-Nexis is an example of a software package that includes a look-ahead feature. The coder may begin by triggering a single purpose macro which moves only the viewer interface to the next document. The coder may then examine the entirety of the document before triggering a coding macro which enters coding selections. In this configuration, the coding macro may begin by moving the coding interface to the next document before the coding selections are entered. This approach appears slightly different from the traditional way of coding legal documents and may work well in situations where the legal document coder is coding documents where he or she is unable to anticipate how the next document should be coded, for example collections of electronic documents such as emails. This approach may add the speed and efficiency of using macros but, like the previously discussed approach, appears slower than anticipatory coding. By using this approach, a competent legal document coder may code between 100 and 150 documents an hour, or between 800 and 1200 documents in an 8 hour period. The key distinguishing feature of this approach, rather than the first, in terms of efficiency, is that it may allow the legal document coder to seamlessly switch from non-anticipatory macro assisted coding with look-ahead to anticipatory macro assisted coding by not triggering the single purpose macro moving the viewer interface to the next document.

Anticipatory macro assisted coding may entail coding the next document before the coder examines the document. This approach may work particularly well in large batches of similar documents which all need to be coded the same way and/or where the legal document coder is able to anticipate to a reasonable degree of certainty how the next document should be coded. Each time it is triggered, the coding macro may move both the coding and viewer interfaces to the next document and enter coding selections in the coding interface while the legal document coder examines the first page of the document in the viewer interface. Once the coding selections have been entered, and the cursor has returned to the point of origin, the coder may examine the remaining pages of the document to ensure that it is correctly coded. This approach of coding appears significantly faster and more efficient than either of the two previously discussed approaches. Where it is possible to code a document using the first approach and entering only two or three keyboard or voice inputs (one input to turn the pages if the document is longer than one page, one input to code the document and one input to move to the next document), this approach may allow the coder to accomplish the same task by entering only one or two inputs (one input to move to the next document and enter coding, one input to turn the pages if the document is longer than one page).

The number of documents coded using this approach, in an 8 hour period in real world conditions, appears to have been measured at 2,527 documents, more than 4 times the number of documents a competent legal document coder using manual mouse and keyboard inputs would be expected to code in the same period. The maximum coding speed using this approach appears also to have been measured at 400 documents in a single one hour period, more than half of what a competent legal document coder using manual mouse and keyboard inputs would be expected to code in an 8 hour period. Additionally, the time needed for coding 1,000 documents using this method appears to have been measured at 2.5 hours.

Macro efficiency may result from a three part improvement. As mentioned herein, macros may increase coding speed because they move the mouse cursor faster than a legal document coder using manual inputs. Coding precision errors may consist of incorrectly coded documents and documents with inconsistent or incomplete coding. An incorrectly coded document may be a document where the legal document coder made the wrong coding selection. A document with incomplete coding may be a document where all of the coding selections are not made, or all of the appropriate check boxes are not checked. An inconsistently coded document may be a document containing coding selections outside of the 18 standard coding selections listed herein, for example a document coded Non-Responsive and Highly Confidential.

Assuming that there is a relationship between the amount of time the legal document coder spends examining the document and the likelihood that the document will be coded correctly, macros may allow the legal document coder to spend more time on examining the document and less time on physically entering coding selections, thus potentially increasing the chance that the legal document coder will make the correct coding selection. Macros virtually never make inconsistent coding selections and rarely if ever fail to complete all of the coding. Thus, both of these two sources of errors may be greatly diminished when macros are used.

A macro hierarchy may have key assignments. Virtually every document will require the execution of one coding macro and, if a look-ahead feature is being used, one single purpose macro to move the viewer interface portion of the legal document coding software to the next document. The use of page turning macros may be necessary for all documents longer than one page. As a result, the lower the number of keys available for macro assignment, the higher the ratio of keys assigned to coding and page turning macros, as opposed to keys assigned to other macros, may be the result. In addition, because coding a document may often require the use of several page turning macros, when only a few keys are available for assignment, greater efficiency can be achieved by assigning more keys to page turning macros than to coding macros. The result may the following macro hierarchy.

1. Coding macros;
2. Page turning macros;
3. Single purpose macros that move both the coding interface and the viewer interface to the next document, or single purpose look-ahead macros in combination with coding macros that move the coding interface to the next document before coding is entered; and
4. Recoding macros, error correcting macros and other single purpose macros.

FIG. 6 is a diagram of the Logitech G13 keyboard 41. An example of configuring keyboard 41 may make it possible to configure coding macros so that they move both the coding interface and the viewer interface to the next document automatically after coding selections have been entered. Using such a configuration, it is possible to code a single page document using only one type of macro and multiple page documents using only two types of macros. In practice however, this type of configuration may prevent the coder from verifying that the document has been correctly and completely coded before moving to the next document. One way to address this drawback is to insert a short delay after the coding selections have been entered and before both the coding and viewer interfaces are moved to the next document.

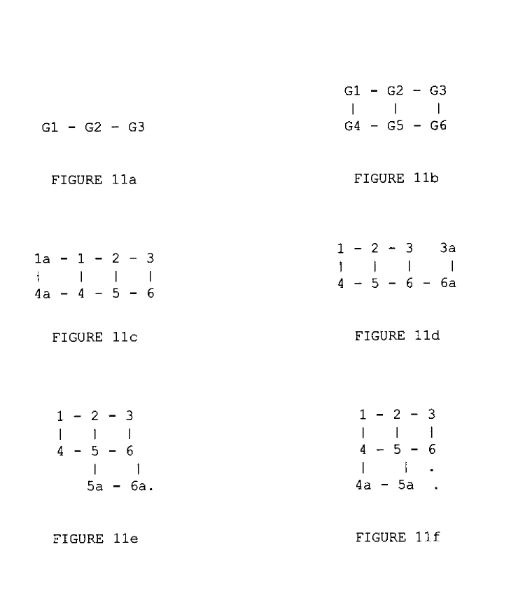

An example 1 may involve configuring a three-key keyboard for efficiently coding legal documents. The example may assume a keyboard consisting of only three keys labelled G1 through G3 (FIG. 11a):
G1-G2-G3
   Assuming a left-handed user may use three fingers to work this keyboard, the macro most often used should be assigned to the index finger since that finger is normally stronger than either the middle finger or the other finger. If the ratio of pages to documents in the database is higher than 2:1, meaning the average document is more than 2 pages in length, the G3 key should be assigned to the page turning macro that moves the viewer interface one page forward. To allow the highest number of documents to be coded using only the three-key keyboard, the two most frequently used coding macros should be assigned to the two remaining keys.

Although, as discussed above, since there may be alternatives to such a configuration, the coding macros may be configured to move both the coding and viewer interfaces to the next document after coding selections have been entered, optionally with an inclusion of a short pause before the coding and viewer interfaces are moved to the next document to allow the legal document coder an opportunity to verify that all of the coding selections have been correctly entered.

An example 2 may involve configuring a six-key keyboard for efficiently coding legal documents. This example may assume a keyboard consisting of six keys in two rows of three keys labelled G1 through G6 with keys G1, G2 and G3 in the top row and keys G4, G5 and G6 in the bottom row so that key G4 is below key G1, key G5 is below key G2 and key G6 is below key G3 as in the following (FIG. 11b):

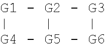

Assuming a left-handed user using three fingers to work the above keyboard, the key most often used should be assigned to the index finger and this should also be the resting position of the index finger during coding. A logical assignment is the G6 key, thus allowing the coder to move the index finger up to G3 when necessary. Assigning the most often used macro to the G3 key may present two issues in practice. First, the middle finger, being naturally longer than the index finger, may normally extend past the G2 key, if the index finger is resting on the G3 key, and will require the coder to change the angle of the hand in order to depress the G2 key. Second, if the index finger is resting on the G3 key, the G6 key may be accidentally depressed when the coder changes hand position, either to depress the G2 key or to rest the palm on the surface where the keyboard is placed.

With the index finger of the left hand on the G6 key, the middle and ring fingers on the left hand may naturally rest on either the G2 and G4 keys or the G2 and G1 keys, depending on the angle of the coder's hand relative to the keyboard. Since the index and middle fingers may be normally stronger than the ring finger, the task of triggering the most commonly used macros, page turning macros or single-purpose look-ahead macros, should be assigned to these two fingers. This leaves the ring finger to trigger coding macros.

Depending on the overall confidentiality level of the documents being reviewed, i.e., Confidential or Highly Confidential, the G1 and G4 keys should be assigned one macro for coding a document Non-Responsive and one macro for coding the document Responsive/Highly Confidential or Responsive/Confidential.

Page turning macros should be assigned depending on the average number of pages of the documents being reviewed. In most circumstances, assignments of one-page, four pages, seven pages or ten pages forward may be sufficient, for example in instances where the page to document ratio is 5:1 or lower. In order to achieve maximum efficiency, the page turning macro for moving the viewer interface one page forward should be assigned to the G6 key and the other page turning macros should be assigned in a clockwise or counter-clockwise pattern of increasing number of pages turned. When a single purpose look-ahead feature is used, the G5 or G3 key should be assigned to this macro. The same may be true for a single purpose macro used to move both the coding interface and the viewer interface to the next document.

Assuming that the G1 and G4 keys are assigned to coding macros, the result may be the following four key assignment patterns.

1. G5 (highest number of pages turned)

G2 (less pages turned than G5)

G3 (less pages turned than G2)

G6 (viewer interface one page forward)

2. G3 (highest number of pages turned)

G2 (less pages turned than G3)

G5 (less pages turned than G2)

G6 (viewer interface one page forward)

3. G5 (a single purpose macro moving both interfaces or a look-ahead macro)

G2 (highest number of pages turned)

G3 (less pages turned than G2)

G6 (viewer interface one page forward)

4. G3 (a single purpose macro moving both interfaces or a look-ahead macro)

G2 (highest number of pages turned)

G5 (less pages turned than G2)

G6 (viewer interface one page forward)

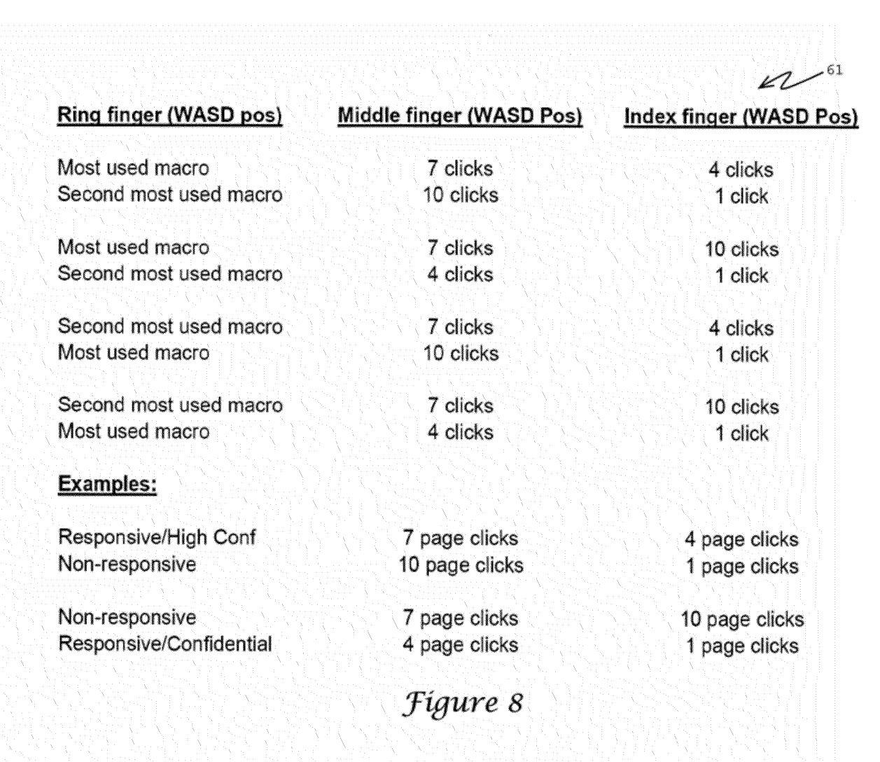

An example 3 may involve configuring the G13 keyboard 41 in FIG. 6 for efficiently coding legal documents. The Logitech G13 keyboard may contain 22 keys numbered from G1 to G22 and three mode keys labelled “M1,” “M2” and “M3” allowing a total of 66 key assignments (22 assignments per mode). Four of the keys (G4, G10, G11 and G12) may contain round depressions allowing the user to place the index, middle and ring fingers in a position known in computer gaming circles as the “WASD position.” (This is also the same position described in example 1 with the index finger resting on G6, middle finger resting on G2 and the ring finger resting on G4 on a 6-key keyboard described in that example). Two additional keys, G3 and G5, are readily accessible when the index, middle and ring fingers are placed in the “WASD position.” As discussed in example 1, an efficient way to assign the six keys of keyboard area 43 for coding legal documents may be to assign the two most commonly used coding macros to the G3 and G10 keys, and the four most commonly used page turning macros to the G4, G5, G11 and G12 keys of area 43 on keyboard 43. Various WASD finger assignments and positions are shown in a diagram 61 of FIG. 8.

WASD may be a set of four keys on a QWERTY or QWERTZ computer keyboard which mimics an inverted-T configuration of the arrow keys. These keys may often be used to control a character's movement, for instance, in computer games. In the games, W/S may control forward and backward movement and A/D may control strafing left and right.

Because of the construction of the G13 keyboard 41, the natural resting place for the thumb of a left handed user is at or near the G22 key. When a look-ahead function is being used, assigning that function to the G22 key may accomplish three things. First, it may free up the G11 or G5 key for the assignment of an additional page turning macro, thus increasing the precision of the page turning macros in terms of being able to turn the pages of a document with a single keystroke. Second, the thumb is normally a strong finger that can be assigned to a frequent task and this assignment therefore may reduce the overall physical strain on the coder. Third, creating physical space between the look-ahead macro and the coding and page turning macros may result in less accidental triggering of the look-ahead macro, in turn decreasing the need for corrections and increasing efficiency.

The neighbouring G21 key may be easily accessible when the thumb is resting on or near the G22 key, and the G21 key should also be assigned to a frequently used macro that is not a coding or page turning macro. In some cases, this could be the resize document macro which changes the size of the page in the viewer interface so that the reviewer can view the entire page.

It may be sometimes necessary to page backward through a document being coded, for example when the coder spots something requiring closer attention while a page turning macro is running. To accomplish this efficiently using the G13 keyboard, the small joystick in the lower right hand corner may be configured to trigger a single purpose macro that moves the mouse cursor between the page forward and page backward buttons in the viewer interface. When configured in this manner, the document coder may page forward and backward through the document using the G12, G5, G4 and G11 keys and use the joystick to select whether the direction is to be forward or backward.

Coding legal documents may sometimes mean paging through documents that are hundreds of pages in length. One way to accomplish this efficiently may be to create and assign macros that page forward continuously until stopped, or backwards continuously until stopped. Stopping a macro generated by Workplace Macro Pro™ (Workplace Macro Pro) 6.5 from running may normally be accomplished by pressing the “Esc” key. An example of how the G13 keyboard can be configured to handle large documents may be to assign the “Esc” key to G20, page forward to G18, page backward quickly to G17 and page forward quickly to G19. When configured in this manner, the G17, G18 and G19 keys may resemble how keys are normally configured on a video or tape recorder in terms of locating the rewind (G17), play (G18) and fast forward (G19) buttons next to each other.

As discussed herein, the G3 and G10 keys may be configured to trigger the two of most commonly used coding macros. One way of configuring the G2, G3, G9, G10, G15 and G16 keys may be to assign responsiveness coding to G3, G10 and G16 and privilege coding to G2, G9 and G15 so that G3, G10 and G16 code documents responsive with different sub-coding for confidentiality and G2, G9 and G15 code documents privileged with different sub-coding for either redacting or withholding. Because there may be a total of eight possible coding selections related to privilege and confidentiality, the three most commonly used may be assigned if the G2, G9 and G15 keys are used for this purpose. This will normally entail setting a uniform level of confidentiality for the three privilege macros so that all three macros only differ as to whether they redact or withhold the document. The remaining five coding selections related to privilege may need to be coded by hand.

While it may be logical to have the macros for coding documents Non-Responsive near the G2, G3, G9, G10, G15 and G16 Responsiveness/Privilege/Confidentiality macro cluster, it appears much more efficient in practice to have the macros for non-responsive coding assigned to one of the keys on the edges of the G13 keyboard when coding largely responsive documents with an occasional non-responsive document appearing infrequently, or to create a different mode (M2 or M3) for coding a range of documents that are largely non-responsive with an occasional responsive document appearing infrequently. An example of this assignment may be to assign the macro for coding non-responsive to the G7 key, the macro for one page click to the G14 key and the macro for “look ahead” to the key immediately below the joystick in the lower right-hand corner of the G13 keyboard. Such a configuration may allow the coder to move the ring finger to G7, the index finger to G14 and the thumb to the key immediately below the joystick (“Dot Button D”), thus placing the entire hand in a secondary position for coding non-responsive documents. When creating a second mode (M2) to code non-responsive documents, the G7 key may be configured to trigger the most common of the responsiveness macros, allowing the coder to move the hand to the right when an occasional responsive document appears.

Error correcting macros may, because of their infrequent use, be assigned to keys on the edges of the G13 keyboard. They may also be assigned in terms of the frequency with which they will be used for recoding. An example of this configuration may be to assign to the G1 key a macro that changes coding of a document from non-responsive to responsive and highly confidential, and the G8 key to a macro that changes the coding of a document from responsive to non-responsive. If a majority of the documents are being coded confidential rather than highly confidential, the G1 key may be assigned to change the coding from non-responsive to responsive and confidential.

An example 4 may involve a project specific macro set. The macro set used for legal document review and coding may be performed using Concordance/IPRO legal document coding software package from Lexis Nexis. In addition, Concordance/IPRO may have been configured to allow the coder to use drop down boxes rather than check marks (tags) to enter his or her coding. Coding selections may be entered by way of three drop down boxes (labelled “Responsiveness,” “Confidentiality” and “Privilege”) appearing sequentially in the Concordance coding interface after the coder clicks on the “RESPONSIVE” line in the Concordance coding interface to activate the first drop down box. In order to allow the coder to make all of the 18 possible coding selections shown in FIG. 4, the three drop down boxes may contain the following coding selections.

1. Responsiveness Drop Down Box coding selections:

Responsive—not privileged or redacted

Responsive—privileged (redacted for confidentiality)

Responsive—privileged (redacted for privilege)

Responsive—privileged (withhold)

Non-responsive

2. Confidentiality Drop Down Box coding selections:

Highly confidential

Confidential

Public

3. Privilege Drop-Down Box coding selections:

Attorney client

Work product

Attorney client and work product

Each drop-down box may allow the reviewer to highlight a choice and click either “Accept” or “Quit” to move to the next drop down box, or double click on the selected choice to move to the next drop down box. Coding a document Non-Responsive may mean clicking on the RESPONSIVE line in the Concordance coding interface, selecting Non-Responsive from the first drop down box and hitting “Accept” and then hitting “Quit” twice to close the next two drop down boxes. In addition to making coding choices, coders may be required to place checkmarks in check boxes (using the Concordance coding interface's tags functionality) indicating the level of attorney review (“1AR” or “2AR”) as well as the coder's initials (“HWW”).

The macro set was used in a project for coding approximately 97,000 documents/652,000 pages out of a total of 1.1 million documents. Minor adjustments were made to key assignments to increase the efficiency of the coding relative to the types of documents encountered during the review.

1. Two modes (M1 and M2) were created in order to allow for coding large sets of responsive or non-responsive documents using anticipatory macro assisted coding.
2. Three specific error correcting macros were created to address issues relating to network lag. These three macros rechecked the level of attorney review check box (G2), the coder initials check box (G9), or both check boxes (G15).
3. Because of the high page to document ratio (˜6.5/1), two additional page turning macros were assigned to the G6 and G13 keys to allow four and five pages to be turned by way of a single keyboard input. The number of page turns assigned to the G5 key was increased from five to six in order not to duplicate the assignment at the G6 key.
4. Because of the relatively low number of privileged documents encountered during the review (less than 1%), privilege coding was done by hand. No coding macros coding for privilege were necessarily assigned to the G13 keyboard during this project.
5. Within the documents that were coded responsive, more documents were coded highly confidential than public, and more documents were coded public than confidential. The G3, G10 and G16 keys were therefore arranged by frequency of use in order to code responsive documents as highly confidential (G3), public (G10) and confidential (G16).
6. Voice command using VR Commander 3.1 software was implemented, but only used for coding approximately 2,000 documents. VR Commander 3.1 was configured so that the coder could read the number of pages to be turned. Reading the number “six” triggered a macro that clicked five times on the next page button in the IPRO viewer interface. Moving the mouse cursor to the page back button in the IPRO interface was configured as a voice command, but the command was not necessarily used in practice. Turning pages backwards using voice command was accomplished by using the commands “back” and “stop” when the desired page was reached.
7. A separate mode (M3) for performing second attorney review was incorporated in the later stages of the project. Using this mode, a second attorney review of approximately 30,000 additional documents was performed. A single purpose macro moving both the Concordance coding interface and the IPRO viewer interface to the next document was created and assigned to the G3 key. Five additional recoding macros were created and assigned to the G2, G7, G9, G14 and G15 keys. In order to avoid accidentally triggering recoding macros, the G10, G6 and G13 keys were left unassigned. This created a physical separation of the keys assigned to page turning macros (G12, G5, G4 and G11) and the keys assigned to recoding macros (G1, G2, G7, G8, G9, G14, G15 and G16).
8. Voice command was available, but was not necessarily used during the second attorney review.

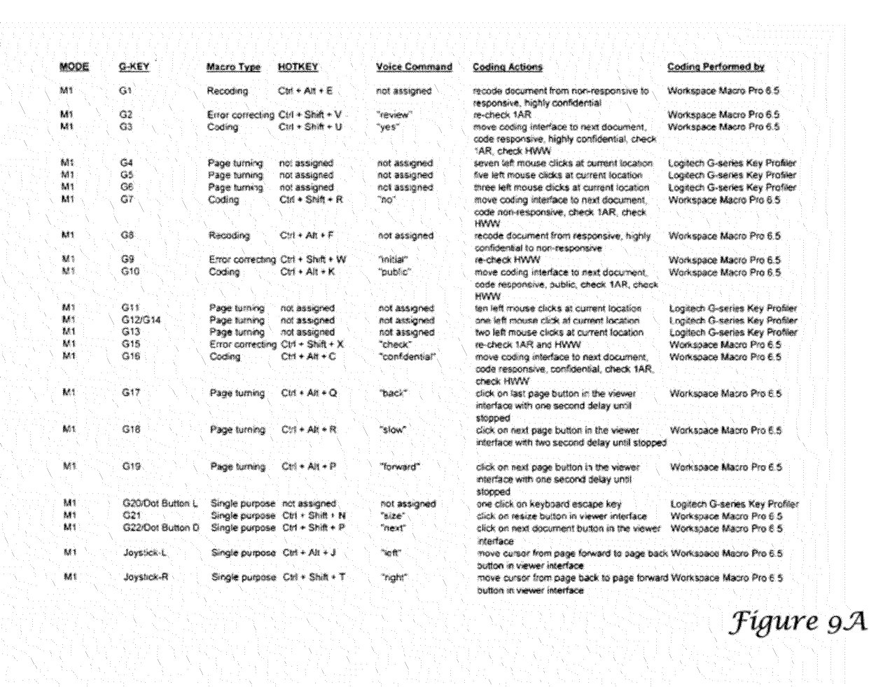

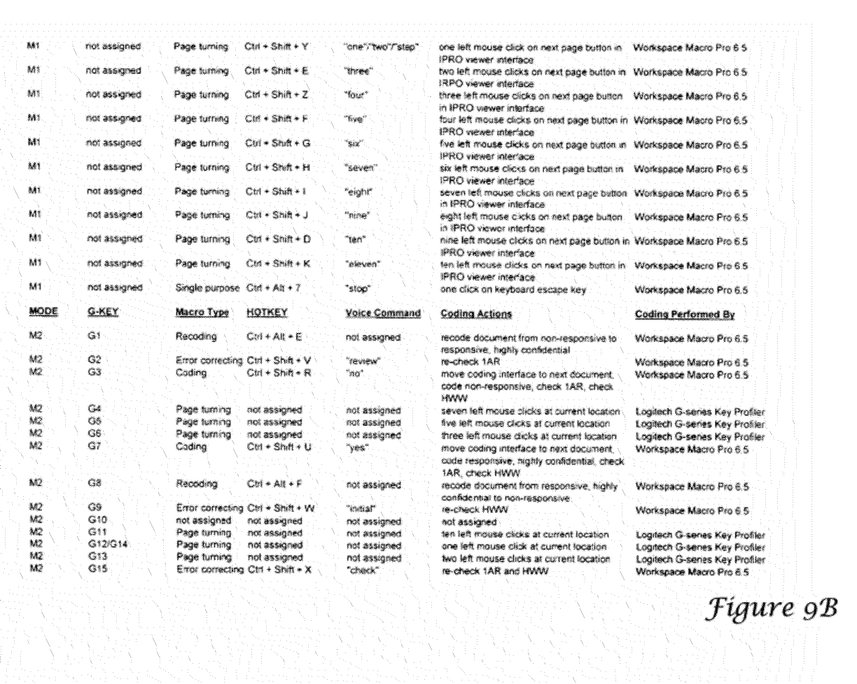

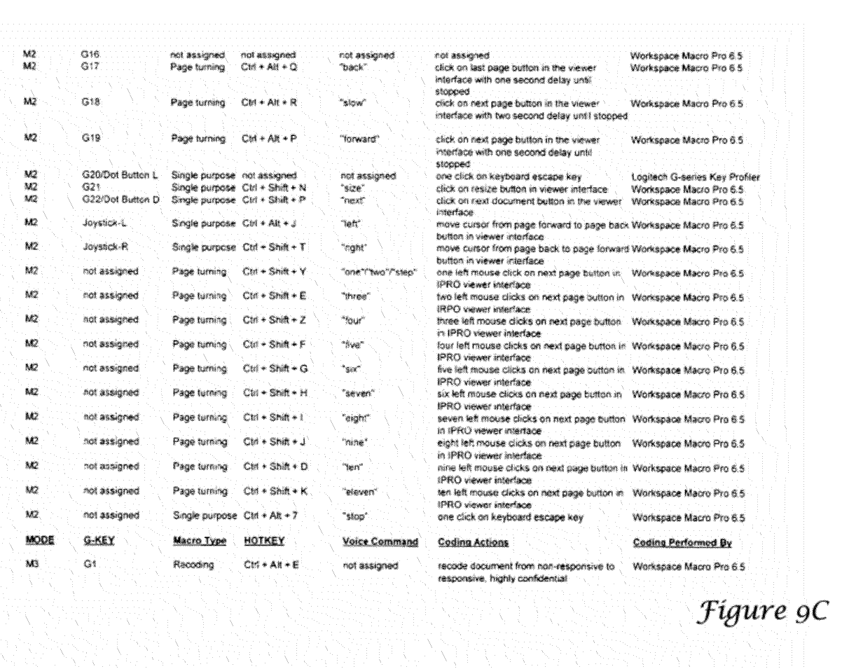

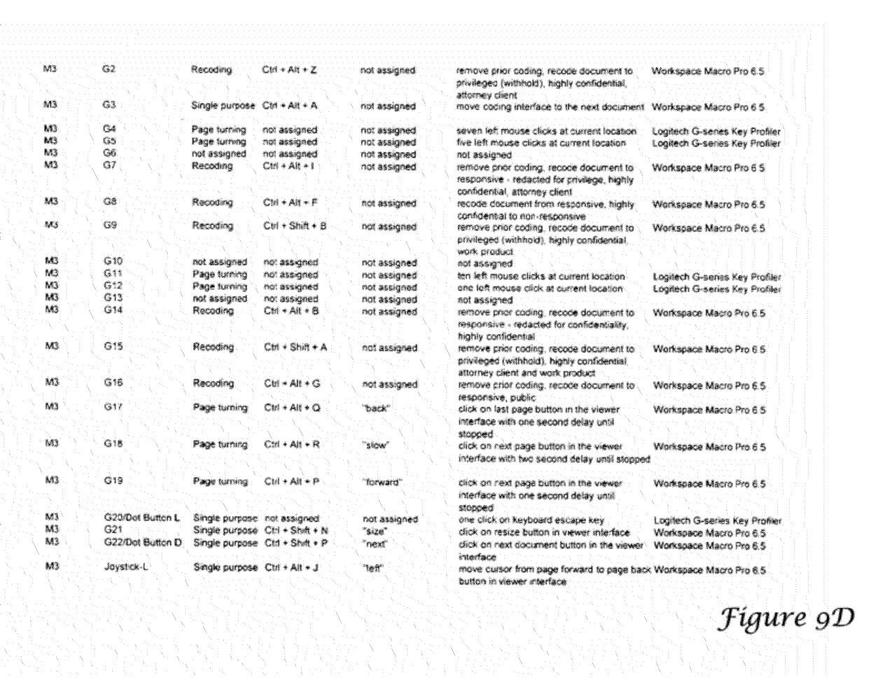

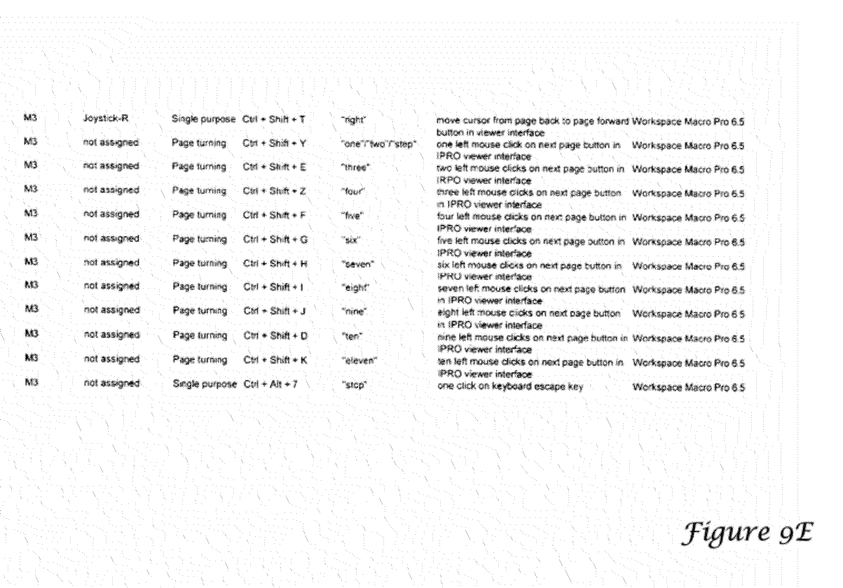

FIGS. 9a, 9b, 9c, 9d and 9e illustrate the various macro types, hotkeys, voice commands, coding actions and the software packages which may used in the present system and approach. These are illustrative examples. Other layouts may be used instead.

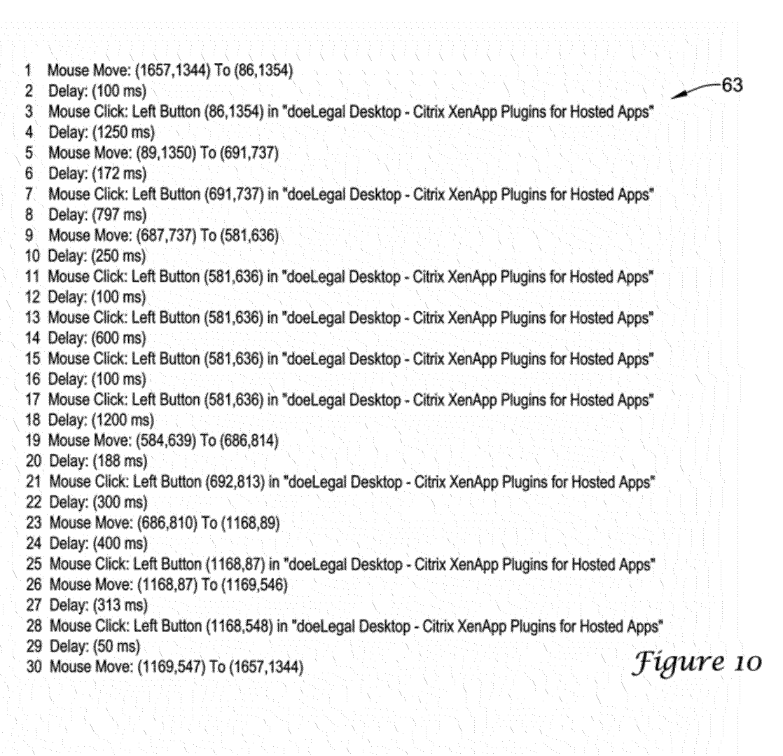

An example may involve a project-specific coding macro. The coding macro may perform the following actions as illustrated in a diagram 63 of FIG. 10, and recited in the following.

1. Moves the mouse cursor from point of origin in IPRO viewer interface to the “next document” button in Concordance coding interface
2. Delay of 0.1 second
3. Left mouse click on the “next document” button in the Concordance coding interface in order to move both the Concordance coding interface and the IPRO viewer interface to the next document
4. Delay of 1.25 seconds (waiting for both interfaces to update)
5. Moves the mouse cursor to the “responsiveness” category in Concordance coding interface
6. Delay of 0.172 second
7. Right mouse click in order to request that the Concordance coding interface output drop down boxes
8. Delay of 0.797 second (waiting for first drop down box to appear)
9. Moves mouse cursor to “Responsive—not privileged or redacted” in first drop down box
10. Delay of 0.250 second (waiting for first drop down box to update)
11-13. Double left mouse clicks on “Responsive—not privileged or redacted” in first drop down box
14. Delay of 0.6 second (waiting for second drop down box to appear)
15-17. Double left mouse clicks on “Highly Confidential” in second drop down box
18. Delay of 1.2 seconds (waiting for third drop down box to appear)
19. Moves the mouse cursor to “Quit” button in the third drop down box
20. Delay of 0.188 second
21. Left click on “Quit” to close third drop down box
22. Delay of 0.3 second (waiting for third down box to disappear)
23. Moves the mouse cursor to first tags check box (“1AR”) in Concordance coding interface
24. Delay of 0.4 second (additional wait period to ensure that check box is ready to be coded)
25. Left click on “1AR” check box in Concordance coding interface to enter coding
26. Moves the mouse cursor to second check box (“R-HWW”) in Concordance coding interface
27. Delay of 0.313 second (waiting for first check box to update)
28. Left click on “R-HWW” checkbox in Concordance coding interface to enter coding
29. Delay of 0.05 second (waiting for second check box to update)
30. Returns the mouse cursor to point of origin in IPRO viewer interface.

The delays in the above list appear as a combination of delays recorded at the time the macro was created and delays that have subsequently been adjusted in order to make the macro run more efficiently. When the macro is used for legal document coding, Workspace Macro Pro 6.5 replays the macro in “SMART Macro High-Speed Replay (faster)” mode which significantly shortens the delays. The total running time of the entire macro during actual use is around 3 seconds.

Returning to the topic of key patterns, any arrangement of six keys where the two outside keys (the 1:4 or 3:6 key pairs) may be assigned to coding macros and the remaining four keys may be either (1) all assigned to page turning macros in a ascending or descending, clockwise or counterclockwise pattern, or (2) three of the four keys may be assigned to page turning macros in an ascending or descending, clockwise or counterclockwise pattern and the fourth key may be assigned to a look-ahead macro.

Two keys may be added on the side away from the coding macros to create a five or six key ascending or descending, clockwise or counterclockwise pattern (i.e., five keys if a look-ahead macro is used, six keys if all six keys are assigned to page turning macros) of page turning macros on what then effectively can become an eight-key keyboard.

Key patterns may incorporate (FIGS. 11c and 11d, respectively):

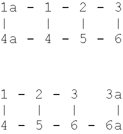

Here the 1-6 keys may provide patterns with either the 1a:4a or 3a:6a key pairs are where additional page turning macros are added. One may avoid a situation where someone who attempts to emulate the system by simply adding keys on the outside or below the page turning keys to expand the pattern. Examples may include the following patterns or scenarios (FIGS. 11e and 11f, respectively):

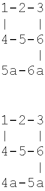

These scenarios indicate where the 1:4 and 3:6 pairs are the coding macros and one may add two more keys under the page turning macros.

One may add two more keys on the sides (i.e., adding two keys on the outside to the right in the main example to give the coder six page-turning macros triggered by keys for 1, 3, 4, 5, 7 and 10 pages). Anything beyond that may not necessarily increase efficiency for the coder.

One may add two additional coding macros on the outside of the coding macros (in the same way that additional page turning macros are added on the opposite side).

To recap, the present approach for macro-assisted document coding, may incorporate viewing a document on a screen of a computer, determining a status of the document, coding the document to indicate the status of the document. The coding of the document may be assisted with one or more coding interface macros. Also, viewing of the document may be assisted with one or more viewer interface macros.

A keyboard of the computer may incorporate one or more keys for activating coding interface macros and one or more keys for activating viewer interface macros. A macro activated by a key may incorporate moving a mouse cursor on the screen, entering text into a field, entering mouse left or right clicks and/or entering one or more keystrokes of one or more keys on the keyboard, to effect actions for coding and/or viewing a document.

Coding interface macros may incorporate coding macros, recoding macros, single purpose macros and/or error correcting macros. Viewer interface macros may incorporate page turning macros and/or single purpose macros. Coding macros may code a document as to responsiveness, level of confidentiality and/or privilege.

Page turning macros may provide one or multiple page turning of a document and single purpose macros may provide resizing a page of a document, zooming in at a particular area of a page of a document, and/or varying an orientation of a page of a document.

Coding interface macros and viewer interface macros may incorporate non-anticipatory macro assisted coding, non-anticipatory macro assisted coding with look-ahead, and/or anticipatory macro assisted coding. Non-anticipatory macro assisted coding may be seamlessly switched to anticipatory macro assisted coding without a change of viewing from one document to another document.

A single page document may be pulled up for viewing and coded with less than two macros and a multiple page document can be pulled up for viewing and coded with less than three macros.

A delay may be introduced between coding a document and pulling up a next document so that a coded document can be verified as having correct coding before coding the next document.

A voice command to the computer may effect a coding interface macro and/or a viewer interface macro.

A system for coding documents may include a processor and a keyboard connected to the processor. The keyboard may have one or more keys which can activate a macro. A macro may perform one or more keystrokes, one or more mouse moves and/or one or more mouse click actions upon activation of the macro. At least one of the one or more keys may interact with a coding interface, and may interact with a viewing interface in instances where a document has more than one page.

The system may also have a screen connected to the processor. A document may be displayed on the screen, evaluated for coding, and coded by pressing the one or more keys to activate a macro to code the document according to at least one macro of a group of macros including non-responsive, and responsive according to the eighteen or so coding macros or categories listed in the description herein.

In the system with the screen connected to the processor, a document may be presented on the screen and evaluated as to its responsiveness. If the document is non-responsive, the document is not necessarily further considered. If the document is responsive, the document may be evaluated and determined as to its level of confidentiality. A macro may be activated to code the document at a determined level of confidentiality.

A document having a level of confidentiality or high confidentiality may be reviewed for privilege. If the document is deemed to be privileged, then a key may be pressed to code the document as privileged and if the document deemed to be completely privileged, then a key may be pressed to code the document as privileged and withheld. If the document is deemed as partially privileged and redacted for privilege, then a key may be pressed to code the document as partially privileged and redacted for privilege. If the document is deemed to be partially privileged and redacted for confidentiality, then a key may be pressed to code the document as partially privileged and redacted for confidentiality.

A page turning macro key may be pressed to page through a document. A single purpose macro key may be pressed to go to another document. A single purpose macro key may be pressed to resize a document on the screen.

A system for coding documents may have a keyboard connected to a computer, a mouse connected to the computer, a display connected the computer and a set of macros installed in the computer. At least one key of the keyboard may be a hot-key. A keystroke of a hot-key may trigger a macro of the set of macros. A macro may incorporate a pre-recorded or pre-programmed pattern of mouse moves, mouse clicks and/or key strokes of one or more keys. The macro may be for facilitating viewing of a document on the display and coding the document with a keystroke of one or more hot-keys. The set of macros may have a subset of coding macros and a subset of viewer macros.

The subset of coding macros may incorporate coding macros for coding a document, recoding macros for changing coding correctly entered, and error correcting macros for changing coding incorrectly entered. The subset of viewer macros may incorporate page turning macros and single purpose macros.

The display may have a coding and information portion and a document portion. The document portion may be for reviewing a document, and the coding and information portion may be for coding selection and information about the document. Upon a review and determination of a coding of the document in the document portion, a keystroke on a hot-key of the keyboard may enter the coding of the document.

A keyboard may have a row of three hot-keys. The hot-key for a macro most often used may be assigned to the index finger. The remaining two hot-keys may be for the next two most often used macros. The index finger may be positioned on an end hot-key of the row of the hot-keys.

A keyboard may have a first row of hot-keys labeled sequentially 1, 2 and 3, and a second row of hot-keys labeled sequentially 4, 5 and 6. The second row of keys may be situated just below and approximately parallel to the first row of keys in that keys 1 and 4 are proximate to each other, keys 2 and 5 are proximate to each other, and keys 3 and 6 are proximate to each other. The hot-key for the macro most often used may be assigned to an index finger. Key 6 may be assigned to an index finger of a left hand. Key 6 may be a resting place for an index finger. Key 3 may also be operated by the index finger. Keys 5 and 2 may be operated by a middle finger and keys 4 and 1 may be operated by a finger left of the middle finger.

In another layout, key 4 may be assigned to an index finger of a right hand and be a resting place for the index finger. Key 1 may also be operated by the index finger. Keys 5 and 2 may be operated by a middle finger, and keys 6 and 3 may be operated by a finger right of the middle finger.

In a layout, the four most often used macros that are not coding macros may triggered by hot keys 2, 3, 5 and 6, and the four most often used macros that are not coding macros may be page turning macros and look-ahead macros. Coding macros may be triggered by keys 4 and 1.

In another layout, the four most often used macros that are not coding macros may be triggered by hot keys 1, 2, 4 and 5. The four most often used macros that are not coding macros may be page turning macros and look-ahead macros. Coding macros may be triggered by keys 3 and 6.

In a layout, keys 1 and 4 may be assigned to the most commonly used coding macros, and the remaining keys may be assigned to the most commonly used page turning macros and look-ahead macros.

In another layout, keys 3 and 6 may be assigned to the most commonly used coding macros, and the remaining keys may be assigned to the most commonly used page turning and look-ahead macros.

Page turning macros may be assigned to keys in an ascending or descending order in either a clockwise or counterclockwise pattern.

A clockwise or counterclockwise pattern of the page turning macro keys may further have two additional keys to the right of the coding macro keys so as to form a six key ascending or descending pattern.

A clockwise or counterclockwise pattern of the page turning macro keys may instead further have two additional keys to the left of the coding macro keys so as to form a six key ascending or descending pattern.

A clockwise or counterclockwise pattern of the page turning macro keys may further have two additional keys to the left of the coding macro keys so as to form a five key ascending or descending pattern with a look-ahead macro assigned to one of the keys.

A clockwise or counterclockwise pattern of the page turning macro keys may further have two additional keys below the page turning macro keys so as to form a six key ascending or descending pattern.

A clockwise or counterclockwise pattern of the page turning macro keys may further have two additional keys below the page turning macro keys so as to form a five key ascending or descending pattern with a look-ahead macro assigned to one of the keys.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A method for macro-assisted document coding, comprising:
viewing a document on a screen of a computer;
determining a status of the document;
coding the document to indicate the status of the document; and
wherein coding of the document is assisted with one or more coding interface macros.

2. The method of claim 1, wherein viewing of the document is assisted with one or more viewer interface macros.

3. The method of claim 2, wherein a keyboard of the computer comprises:
one or more keys for activating coding interface macros; and
one or more keys for activating viewer interface macros.

4. The method of claim 3, wherein a macro activated by a key comprises moving a mouse cursor on the screen, entering text into a field, entering mouse left or right clicks and/or entering one or more keystrokes of one or more keys on the keyboard, to effect actions for coding and/or viewing a document.

5. The method of claim 2, wherein:
coding interface macros comprise:
coding macros;
recoding macros;
single purpose macros; and/or error correcting macros; and
viewer interface macros comprise:
page turning macros; and/or
single purpose macros.

6. The method of claim 5, wherein coding macros code a document as to responsiveness, level of confidentiality and/or privilege.

7. The method of claim 5, wherein:
page turning macros provide one or multiple page turning of a document; and
single purpose macros provide resizing a page of a document, zooming in at a particular area of a page of a document, and/or varying an orientation of a page of a document.

8. The method of claim 2, wherein coding interface macros and viewer interface macros comprise non-anticipatory macro assisted coding, non-anticipatory macro assisted coding with look-ahead, and/or anticipatory macro assisted coding.

9. The method of claim 8, wherein non-anticipatory macro assisted coding can be seamlessly switched to anticipatory macro assisted coding without a change of viewing from one document to another document.

10. The method of claim 5, wherein:
a single page document can be pulled up for viewing and coded with less than two macros; and
a multiple page document can be pulled up for viewing and coded with less than three macros.

11. The method of claim 2, wherein a delay is introduced between coding a document and pulling up a next document so that a coded document can be verified as having correct coding before coding the next document.

12. The method of claim 2, wherein a voice command to the computer can effect a coding interface macro and/or a viewer interface macro.

13. A system for coding documents, comprising:
a processor; and
a keyboard connected to the processor; and
wherein:
the keyboard comprises one or more keys;
the one or more keys can activate a macro;
a macro performs one or more keystrokes, one or more mouse moves and/or one or more mouse click actions upon activation of the macro;
at least one of the one or more keys interacts with a coding interface; and
at least one of the one or more keys interacts with a viewing interface in instances where a document has more than one page.

14. The system of claim 13, further comprising:
a screen connected to the processor; and
wherein:
a document is displayed on the screen;
the document is evaluated for coding; and
the document is coded by pressing the one or more keys to activate a macro to code the document according to at least one macro of a group of macros comprising:
a) Non-responsive;
b) Responsive, Highly Confidential;
c) Responsive, Confidential;
d) Responsive, Public;
e) Responsive, Highly Confidential, Completely Privileged, Attorney Client;
f) Responsive, Highly Confidential, Completely Privileged, Work Product;
g) Responsive, Highly Confidential, Completely Privileged, Attorney Client and Work Product;
h) Responsive, Confidential, Completely Privileged, Attorney Client;
i) Responsive, Confidential, Completely Privileged, Work Product;
j) Responsive, Confidential, Completely Privileged, Attorney Client and Work Product;
k) Responsive, Highly Confidential, Redacted for Confidentiality;
l) Responsive, Confidential, Redacted for Confidentiality;
m) Responsive, Highly Confidential, Redacted for Privilege, Attorney Client;
n) Responsive, Highly Confidential, Redacted for Privilege, Work Product;
o) Responsive, Highly Confidential, Redacted for Privilege, Attorney Client & Work Product;
p) Responsive, Confidential, Redacted for Privilege, Attorney Client;
q) Responsive, Confidential, Redacted for Privilege, Work Product; and/or
r) Responsive, Confidential, Redacted for Privilege, Attorney Client and Work Product.

15. The system of claim 13, further comprising:
a screen connected to the processor; and
wherein:
a document is presented on the screen and is evaluated as to its responsiveness;
if the document is non-responsive, the document is not further considered;
if the document is responsive, the document is evaluated and determined as to its level of confidentiality; and
a macro is activated to code the document at a determined level of confidentiality.

16. The system of claim 15, wherein:
a document having a level of confidentiality or high confidentiality is reviewed for privilege;
if the document is deemed to be privileged, then a key is pressed to code the document as privileged;
if the document deemed to be completely privileged, then a key is pressed to code the document as privileged and withheld;
if the document is deemed as partially privileged and redacted for privilege, then a key is pressed to code the document as partially privileged and redacted for privilege; and/or
if the document is deemed to be partially privileged and redacted for confidentiality, then a key is pressed to code the document as partially privileged and redacted for confidentiality.

17. The system of claim 13, wherein:
a page turning macro key is pressed to page through a document;
a single purpose macro key is pressed to go to another document; and/or
a single purpose macro key is pressed to resize a document on the screen.

18. A system for coding documents comprising:
a keyboard connected to a computer; and
a mouse connected to the computer;
a display connected the computer;
a set of macros installed in the computer;
wherein:
at least one key of the keyboard is a hot-key;
a keystroke of a hot-key triggers a macro of the set of macros;
a macro comprises a pre-recorded or pre-programmed pattern of mouse moves, mouse clicks and/or key strokes of one or more keys; and
the macro is for facilitating viewing of a document on the display and coding the document with a keystroke of one or more hot-keys.

19. The system of claim 18, further wherein the set of macros comprises:
a subset of coding macros; and
a subset of viewer macros.

20. The system of claim 19, wherein:
the subset of coding macros comprises:
coding macros for coding a document;
recoding macros for changing coding correctly entered; and
error correcting macros for changing coding incorrectly entered; and
the subset of viewer macros comprises:
page turning macros; and
single purpose macros.

21. The system of claim 20, wherein the display comprises:
a coding and information portion; and
a document portion.

22. The system of claim 21, wherein:
the document portion is for reviewing a document;
the coding and information portion is for coding selection and information about the document; and
upon a review and determination of a coding of the document in the document portion, a keystroke on a hot-key of the keyboard enters the coding of the document.

23. The system of claim 18, wherein the keyboard comprises:
a row of three hot-keys;
the hot-key for a macro most often used is assigned to the index finger;
the remaining two hot-keys are for the next two most often used macros; and
the index finger is positioned on an end hot-key of the row of the hot-keys.

24. The system of claim 18, wherein the keyboard comprises:
a first row of hot-keys labeled sequentially 1, 2 and 3; and
a second row of hot-keys labeled sequentially 4, 5 and 6;
wherein:
the second row of keys is situated just below and approximately parallel to the first row of keys in that keys 1 and 4 are proximate to each other, keys 2 and 5 are proximate to each other, and keys 3 and 6 are proximate to each other; and
the hot-key for the macro most often used is assigned to an index finger.

25. The system of claim 24, wherein:
key 6 is assigned to an index finger of a left hand;
key 6 is a resting place for an index finger;
key 3 is also operated by the index finger;
keys 5 and 2 are operated by a middle finger; and
keys 4 and 1 are operated by a finger left of the middle finger.

26. The system of claim 24, wherein:
key 4 is assigned to an index finger of a right hand;
key 4 is a resting place for the index finger;
key 1 is also operated by the index finger;
keys 5 and 2 are operated by a middle finger; and
keys 6 and 3 are operated by a finger right of the middle finger.

27. The system of claim 25, wherein:
the four most often used macros that are not coding macros are triggered by hot keys 2, 3, 5 and 6; and
the four most often used macros that are not coding macros are page turning macros and look-ahead macros; and
coding macros are triggered by keys 4 and 1.

28. The system of claim 26, wherein:
the four most often used macros that are not coding macros are triggered by hot keys 1, 2, 4 and 5;
the four most often used macros that are not coding macros are page turning macros and look-ahead macros; and
coding macros are triggered by keys 3 and 6.

29. The system of claim 24, wherein:
keys 1 and 4 are assigned to the most commonly used coding macros; and
the remaining keys are assigned to the most commonly used page turning macros and look-ahead macros.

30. The system of claim 24, wherein:
keys 3 and 6 are assigned to the most commonly used coding macros; and
the remaining keys are assigned to the most commonly used page turning and look-ahead macros.

31. The system of claim 29, wherein the page turning macros are assigned to keys in an ascending or descending order in either a clockwise or counterclockwise pattern.

32. The system of claim 30, wherein the page turning macros are assigned to keys in an ascending or descending order in either a clockwise or counterclockwise pattern.

33. The system of claim 31, wherein the clockwise or counterclockwise pattern of the page turning macro keys further comprises two additional keys to the right of the coding macro keys so as to form a six key ascending or descending pattern.

34. The system of claim 32, wherein the clockwise or counterclockwise pattern of the page turning macro keys further comprises two additional keys to the left of the coding macro keys so as to form a six key ascending or descending pattern.

35. The system of claim 31, wherein the clockwise or counterclockwise pattern of the page turning macro keys further comprises two additional keys to the left of the coding macro keys so as to form a five key ascending or descending pattern with a look-ahead macro assigned to one of the keys.

36. The system of claim 32, wherein the clockwise or counterclockwise pattern of the page turning macro keys further comprises two additional keys to the left of the coding macro keys so as to form a five key ascending or descending pattern with a look-ahead macro assigned to one of the keys.

37. The system of claim 31, wherein the clockwise or counterclockwise pattern of the page turning macro keys further comprises two additional keys below the page turning macro keys so as to form a six key ascending or descending pattern.

38. The system of claim 32, wherein the clockwise or counterclockwise pattern of the page turning macro keys further comprises two additional keys below the page turning macro keys so as to form a six key ascending or descending pattern.

39. The system of claim 31, wherein the clockwise or counterclockwise pattern of the page turning macro keys further comprises two additional keys below the page turning macro keys so as to form a five key ascending or descending pattern with a look-ahead macro assigned to one of the keys.

40. The system of claim 32, wherein the clockwise or counterclockwise pattern of the page turning macro keys further comprises two additional keys below the page turning macro keys so as to form a five key ascending or descending pattern with a look-ahead macro assigned to one of the keys.
